(19) United States
(12) Patent Application Publication
(10) Pub. No.: US 2005/0000215 A1
(43) Pub. Date: Jan. 6, 2005

(54) Internal combustion engine

(76) Inventor: Michael Baeuerle, Ditzingen-Heimerdingen (DE)

Correspondence Address: KENYON & KENYON, ONE BROADWAY, NEW YORK, NY, 10004, US

(21) Appl. No.: 10/871,666

(22) Filed: Jun. 18, 2004

(30) Foreign Application Priority Data
Jun. 20, 2003 (DE) 10327686.6

(51) Int. Cl. F02B 33/44

(52) U.S. Cl. 60/608; 60/612

(57) ABSTRACT

An internal combustion engine has a turbocharger system that includes an exhaust gas turbocharger and an auxiliary compressor and is connected to an engine control system via which it is controlled as a function of engine operating parameters. This provides a relatively low-cost method for precisely controlling or regulating the secondary air by integrating the auxiliary compressor into a secondary air provision system that is operable by the control system within a load and/or rotational speed range below the boost range during a warm-up phase.

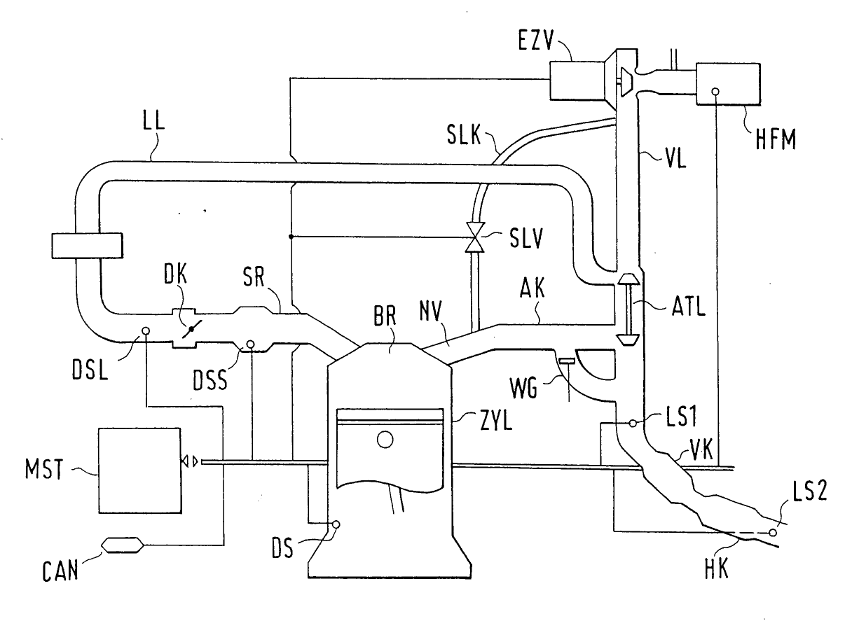

### FIELD OF THE INVENTION

The present invention relates to an internal combustion engine having a turbocharger system that includes an exhaust gas turbocharger and an auxiliary compressor and is connected to an engine control system via which it is controlled as a function of engine operating parameters.

### BACKGROUND INFORMATION

An internal combustion engine of this type is described in German Patent No. DE 31 00 732. In this conventional internal combustion engine, a turbocharger system having an exhaust gas turbocharger and an auxiliary compressor is provided to increase power. A turbocharger system of this type is usually in operation only within a boost range above a certain load.

To obtain the best possible exhaust gas results, particularly during a warm-up phase, secondary air systems, in particular secondary air pumps, are often used, the purpose of which is to achieve, as far as possible, complete post-combustion of the exhaust gas exiting the combustion chamber of the cylinder. Secondary air systems of this type are quite expensive, and functional improvements are also desirable.

### SUMMARY

The object of the present invention is to provide an internal combustion engine of the aforementioned type that makes it possible to improve secondary air supply, while minimizing costs.

According to an example embodiment of the present invention, an auxiliary compressor is integrated into a secondary air provision system that is operable by the control system within a load and/or rotational speed range below the boost range during a warm-up phase.

Therefore, the auxiliary compressor of the turbocharger system, which is already present, is advantageously used to generate and supply secondary air. Advantageously, this arrangement is simultaneously able to use the control system, which is provided for its operation, as well as the sensors and/or control parameters contained therein.

According to an example embodiment that is suitable for the construction, the secondary air provision system has a secondary air channel that is connected to a connecting line between the auxiliary compressor and the exhaust gas turbocharger as well as to a section of an exhaust gas channel between the combustion chamber of a given cylinder and the exhaust gas turbocharger; and a secondary air valve that is actuatable by the control system is provided in the secondary air channel. This makes it possible to extract the secondary air, in particular in the vicinity of the auxiliary compressor, and supply it to the post-combustion chamber and the thermal reactor located therein.

A precise adjustment to the existing operating conditions is achieved by providing the secondary air provision system with a regulating system that makes it possible to directly and/or indirectly regulate a secondary air mass throughput.

According to an example embodiment that is advantageous for the regulation, the secondary air mass throughput and/or an exhaust gas value detected by a lambda probe is/are used as the controlled variable.

A further advantage for the construction and precise adjustment of the secondary air provision is that a setpoint rotational speed of the auxiliary compressor and/or a setpoint position of the secondary air valve is/are used as the manipulated variable.

To minimize costs by employing existing components, it is also expedient to use the difference between a total air mass throughput and an engine air mass throughput as the secondary air mass throughput.

According to an advantageous embodiment, a total air mass meter is provided for detecting the total air mass throughput, and the engine air mass throughput is determinable by the control system on the basis of a signal of a boost pressure sensor or an intake manifold pressure sensor.

The precision of the secondary air supply is also improved by selecting a setpoint secondary air mass throughput as a function of the engine temperature, exhaust gas temperature, intake air temperature, exhaust gas lambda value or engine speed or a combination of at least two of these variables. The setpoint values are advantageously stored in a memory unit of the control system.

### BRIEF DESCRIPTION OF THE DRAWINGS

The present invention is explained in greater detail below on the basis of an exemplary embodiment with reference to the FIGURE.

The FIGURE shows a schematic representation of parts of an internal combustion engine according to an example embodiment of the present invention.

### DETAILED DESCRIPTION OF THE EXAMPLE EMBODIMENT

An exhaust turbocharger AT is positioned in an exhaust gas line system connected to combustion chamber BR of a given cylinder ZYL, exhaust gas turbocharger ATL being assisted by an electrical auxiliary supercharger EZV as an auxiliary compressor to supply from the exhaust gas charge air back to combustion chamber BR via a throttle valve DK in an intake manifold SR within a boost range above a certain load or rotational speed range via a charge air line LL.

The exhaust gas system also includes an overflow line WG (waste gate) that circumvents exhaust gas turbocharger ATL and has an actuator, while a primary catalytic converter VK having an upstream lambda probe LS1 and a main catalytic converter HK having a downstream lambda probe LS2 are positioned in a manner that is known per se at the output end of overflow line WG and exhaust gas turbocharger ATL. A boost pressure sensor DSL is located upstream from throttle valve DK in charge air line LL, and an intake manifold pressure sensor DSS is positioned in the area of intake manifold SR. Both sensors, as well as other monitoring elements, are connectable via a bus, in particular a CAN bus, to an engine control system MST for the purpose of transmitting important engine data thereto. The monitoring elements include, among other things, a rotational speed sensor DS and aforementioned lambda probes LS1, LS2.

Auxiliary compressor EZV is in flow communication with exhaust gas turbocharger ATL via a connecting line VL. A secondary air channel SLK having a secondary air valve SLV branches from connecting line VL in the vicinity of auxiliary compressor EZV, while its other end is connected to exhaust gas channel AK in the area of post-combustion chamber NV. Connecting line VL is also connected to an air mass meter HFM having a hot film air mass meter that may be used to detect the total air mass throughput, detected signals being supplied to control system MST, and it also being possible for control system MST to actuate air mass meter HFM.

For actuating purposes, control system MST also communicates, among other things, with electromotor-driven auxiliary compressor EZV and secondary air valve SLV to actuate or regulate them, as needed, as a function of other engine operating parameters.

Below the boost range, i.e., in particular during the warm-up phase, auxiliary compressor EZV is used within a secondary air-relevant load/rotational speed range to provide secondary air that is supplied to post-combustion chamber NV via secondary air channel SLK by controlling secondary air valve SLV, thereby providing the right amount of oxygen needed to achieve, as far as possible, complete post-combustion without a disproportionate oxygen surplus or shortfall. The secondary air mass throughput may be precisely metered by appropriately actuating auxiliary compressor EZV and actuating secondary air valve SLV. It is advantageous, although not necessary, to use a secondary air valve SLV that is able to continuously adjust the setpoint position of the passage cross-section. It is also useful to actuate auxiliary compressor EZV at maximum power if possible during the warm-up phase to provide the hottest possible (charge) air, thus improving post-combustion results and obtaining optimum operating conditions as quickly as possible, which also enables the catalytic converter to effectively perform its function in achieving desirable exhaust gas results.

To detect the secondary air mass throughput, the difference is determined between the total air mass throughput detected by air mass meter HFM and the engine air mass throughput calculated, for example, by the intake manifold pressure sensor DSS in conjunction with the engine speed. Before the secondary air provision system is activated, therefore, it is possible to calculate the total air mass throughput using air mass meter HFM and to calculate the engine air mass throughput using intake manifold pressure sensor DSS in conjunction with the engine speed and to improve the accuracy of the values obtained via intake manifold pressure sensor DSS and air mass meter HFM by using an equalization function. After activating the secondary air provision system, the secondary air mass throughput is determined from the aforementioned difference between the total air mass throughput and the engine air mass throughput.

In the regulating circuit for the secondary air mass throughput, the manipulated variable is preferably the setpoint rotational speed of the auxiliary compressor or electrical auxiliary supercharger EZV and/or the setpoint position of secondary air valve SLV, while the controlled variable is the secondary air mass throughput and/or the lambda value of the exhaust gas detected by lambda probe LS1 or LS2. A P, PI, PID controller or another suitable controller, preferably one having a precontrol function, is used as the controller. The setpoint secondary air mass throughput may be dependent, for example, on the engine, exhaust gas and/or intake air temperature, the engine speed or a similar value. Alternatively, a setpoint value may also be specified for the exhaust gas composition, which is determined from the measurement results of lambda probes LS1, LS2 and is advantageously approximately or exactly lambda=1.

As an alternative to detecting the engine air mass throughput using intake manifold pressure sensor DSS in conjunction with the engine speed or engine load, it is also possible to detect the engine air mass throughput on the basis of data supplied by boost pressure sensor DSL in a manner that is known per se.

The control system may be advantageously designed so that, when the driver requests high power by pressing the gas pedal, the secondary air valve closes to interrupt the provision of secondary air, and the charge air of auxiliary compressor EZV is used to assist, for example, driving off.

1. An internal combustion engine having a turbocharger system, comprising:
an exhaust gas turbocharger;
an auxiliary compressor;
an engine control system via which the turbocharger system is controlled as a function of engine operating parameters; and
a secondary air provision system that is operable by the control system within at least one of a load and a rotational speed range below a boost range during a warm-up phase, the auxiliary compressor being integrated into the secondary air provision system.

2. The internal combustion engine as recited in claim 1, wherein the secondary air provision system has a secondary air channel that is connected to a connecting line between the auxiliary compressor and an exhaust gas turbocharger, and to a section of an exhaust gas channel between a combustion chamber of a cylinder and the exhaust gas turbocharger, and wherein a secondary air valve that is actuatable by the control system is provided in the secondary air channel.

3. The internal combustion engine as recited in claim 1, wherein the secondary air provision system includes a regulating or control system to regulate or control a secondary air mass throughput.

4. The internal combustion engine as recited in claim 2, wherein at least one of a secondary air mass throughput and an exhaust gas value detected by a lambda probe is used as a controlled variable.

5. The internal combustion engine as recited in claim 3, wherein at least one of a setpoint rotational speed of the auxiliary compressor and a setpoint position of the secondary air valve is used as a manipulated variable.

6. The internal combustion engine as recited in claim 4, wherein a difference between a total air mass throughput and an engine air mass throughput is used as the secondary air mass throughput.

7. The internal combustion engine as recited in claim 6, further comprising:
a total air mass meter configured to detect the total air mass throughput;
wherein the engine air mass throughput is determinable by the control system based on a signal of a boost pressure sensor or an intake manifold pressure sensor.

8. The internal combustion engine as recited in claim 3, wherein a setpoint secondary air mass throughput is selected as a function of at least one of an engine temperature, an exhaust gas temperature, an intake air temperature, an exhaust gas lambda value or engine speed.
